(19) United States
(12) Patent Application Publication
(10) Pub. No.: US 2020/0275238 A1
(43) Pub. Date: Aug. 27, 2020

(54) COMMUNICATION CONTROL APPARATUS, COMMUNICATION CONTROL METHOD, AND PROGRAM

(71) Applicant: NEC Corporation, Tokyo (JP)

(72) Inventor: Atsunori ISOZUMI, Tokyo (JP)

(73) Assignee: NEC Corporation, Tokyo (JP)

(21) Appl. No.: 16/798,586

(22) Filed: Feb. 24, 2020

(30) Foreign Application Priority Data
Feb. 25, 2019 (JP) 2019-031473

(51) Int. Cl. H04W 4/02; H04B 17/309; H04B 1/00

(52) U.S. Cl. CPC H04W 4/027; H04B 1/006; H04B 17/309; H04W 4/023

(57) ABSTRACT

A communication control apparatus includes: current position detection means for detecting a current position of a mobile body; position estimation means for estimating a movement position of the mobile body after an elapse of a predetermined amount of time; information acquisition means for acquiring radio state information in which a position of the mobile body, radio means of the mobile body, and quality information indicating a quality of a radio state with respect to the position and the radio means of the mobile body are associated with each other; radio determination means for determining whether or not to change the radio means of the mobile body by comparing the quality information at the current position with the quality information at the movement position and; radio switching means for switching the radio means of the mobile body in accordance with a result of the determination.

### INCORPORATION BY REFERENCE

This application is based upon and claims the benefit of priority from Japanese patent application No. 2019-031473, filed on Feb. 25, 2019, the disclosure of which is incorporated herein in its entirety by reference.

### TECHNICAL FIELD

The present disclosure relates to a communication control apparatus, a communication control method, and a program for a mobile body.

### BACKGROUND ART

In related systems, radio switching is performed after communication quality deteriorates. This causes a problem that the radio switching blocks communication once or the radio switching cannot be adapted to places where a radio environment changes with time.

In contrast, for example, a technique in which a radio status for each area is acquired by moving a radio portable terminal is known (see Japanese Unexamined Patent Application Publication No. 2007-194692). However, when a new route for an automated guided vehicle is set, a radio status cannot be acquired unless the vehicle travels the route once.

A technique in which a mobile communication apparatus has a single communication method is known (see Japanese Unexamined Patent Application Publication No. 2004-228851). However, when the communication method cannot be used, communication cannot be maintained by switching it to another communication method.

A technique for acquiring a communication status from an oncoming vehicle is known (see Japanese Unexamined Patent Application Publication No. 2013-197831). However, a radio status cannot be predicted when there is no oncoming vehicle.

A technique for detecting whether interference is received from positional information of an access point and a position of the own apparatus is known (see Japanese Unexamined Patent Application Publication No. 2011-142562). However, an appropriate determination cannot be made in an environment where there is a noise source or a reverberation occurs like in a factory.

### SUMMARY

An object of the present disclosure is to provide a communication control apparatus, a communication control method, and a program that solve any of the above-described problems.

In order to achieve the aforementioned object, one aspect of the present disclosure is a communication control apparatus, including:
current position detection means for detecting a current position of a mobile body;
position estimation means for estimating a movement position of the mobile body after an elapse of a predetermined amount of time;
information acquisition means for acquiring radio state information in which a position of the mobile body, radio means of the mobile body, and quality information indicating a quality of a radio state with respect to the position and the radio means of the mobile body are associated with each other;
radio determination means for determining whether or not to change the radio means of the mobile body by comparing the quality information with respect to the radio means of the mobile body at the current position with the quality information with respect to the radio means of the mobile body at the movement position, the quality information being calculated based on the current position of the mobile body detected by the current position detection means, the movement position of the mobile body estimated by the position estimation means, and the radio state information acquired by the information acquisition means; and
radio switching means for switching the radio means of the mobile body in accordance with a result of the determination by the radio determination means.

In order to achieve the aforementioned object, one aspect of the present disclosure may be a communication control method, including:
detecting a current position of a mobile body;
estimating a movement position of the mobile body after an elapse of a predetermined amount of time;
acquiring radio state information in which a position of the mobile body, radio means of the mobile body, and quality information indicating a quality of the radio state with respect to the position and the radio means of the mobile body are associated with each other;
determining whether or not to change the radio means of the mobile body by comparing the quality information with respect to the radio means of the mobile body at the current position with the quality information with respect to the radio means of the mobile body at the movement position, the quality information being calculated based on the detected current position of the mobile body, the estimated movement position of the mobile body, and the acquired radio state information; and
switching the radio means of the mobile body in accordance with the result of the determination.

In order to achieve the aforementioned object, one aspect of the present disclosure may be a program for causing a computer to execute the following processing of:
detecting a current position of a mobile body;
estimating a movement position of the mobile body after an elapse of a predetermined amount of time;
acquiring radio state information in which a position of the mobile body, radio means of the mobile body, and quality information indicating a quality of the radio state with respect to the position and the radio means of the mobile body are associated with each other;
determining whether or not to change the radio means of the mobile body by comparing the quality information with respect to the radio means of the mobile body at the current position with the quality information with respect to the radio means of the mobile body at the movement position, the quality information being calculated based on the detected current position of the mobile body, the estimated movement position of the mobile body, and the acquired radio state information; and
switching the radio means of the mobile body in accordance with the result of the determination.

According to the present disclosure, it is possible to provide a communication control apparatus, a communication control method, and a program that solve any of the above-described problems.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram showing a schematic system configuration of a communication control apparatus according to an example embodiment of the present disclosure;

FIG. 2 is an example of movement route information;

FIG. 3 is a diagram showing an example of radio state information;

FIG. 4 is a block diagram showing a schematic system configuration of the communication control apparatus according to the example embodiment of the present disclosure;

FIG. 5 is a flowchart showing a flow of a communication control method according to the example embodiment of the present disclosure; and

FIG. 6 is a block diagram showing a schematic system configuration of a communication control apparatus according to another example embodiment of the present disclosure.

### EXAMPLE EMBODIMENTS

Example embodiments of the present disclosure are described hereinafter with reference to the drawings. A communication control apparatus according to an example embodiment of the present disclosure, for example, is mounted on a mobile body such as an automated guided vehicle in a factory and performs communication control of the mobile body.

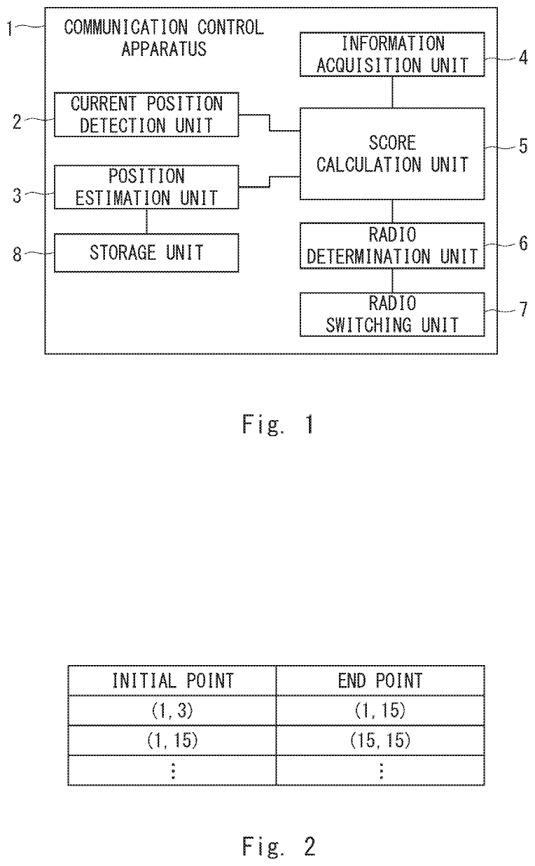

FIG. 1 is a block diagram showing a schematic system configuration of a communication control apparatus according to the example embodiment of the present disclosure. A communication control apparatus 1 according to this example embodiment includes: a current position detection unit 2 that detects a current position of a mobile body; a position estimation unit 3 that estimates a movement position of the mobile body after an elapse of a predetermined amount of time; an information acquisition unit 4 that acquires radio state information; a score calculation unit 5 that calculates a radio score; a radio determination unit 6 that determines whether or not to change a radio mode of the mobile body; a radio switching unit 7 that switches a radio mode of the mobile body; and a storage unit 8.

Note that for example, the communication control apparatus 1 is composed of hardware mainly using a microcomputer including a Central Processing Unit (CPU) that performs control processing, arithmetic processing, and the like, a memory including Read Only Memory (ROM) and Random Access Memory (RAM) that stores a control program, an arithmetic programs, and the like executed by the CPU, and an interface unit (I/F) that externally receives and outputs signals. The CPU, the memory, and the interface unit are connected with each other through a data bus or the like.

The current position detection unit 2 is a specific example of current position detection means. The current position detection unit 2 detects the current position of the mobile body based on, for example, distance information acquired by a distance sensor, map information stored in the storage unit 8 in advance, and a Global Positioning System (GPS) signal. The distance sensor is, for example, an ultrasonic sensor, a radar sensor, and a camera that are provided on the mobile body. The storage unit 8 is composed of the aforementioned memory and the like.

The position estimation unit 3 is a specific example of position estimation means. The position estimation unit 3 calculates a moving direction and a speed of the mobile body based on the current position of the mobile body detected by the current position detection unit 2 and movement route information stored in the storage unit 8. The position estimation unit 3 calculates a movement position of the mobile body after an elapse of a certain amount of time (e.g., after three seconds) based on the calculated moving direction and speed. The mobile body moves in accordance with the movement route information. FIG. 2 is an example of movement route information. The movement route is set by, for example, coordinates of a two-dimensional coordinate system.

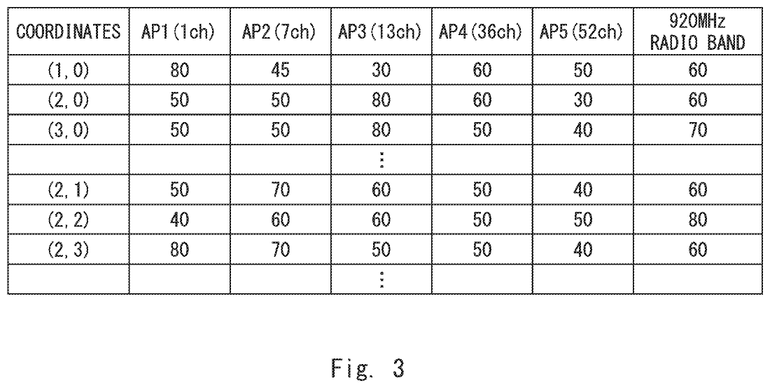

The information acquisition unit 4 is a specific example of information acquisition means. The information acquisition unit 4 acquires radio state information in which the position of the mobile body, the radio mode of the mobile body, and the radio score indicating the quality of the radio state of the mobile body with respect to the position and the radio mode are associated with each other. FIG. 3 is a diagram showing an example of radio state information. The position of the mobile body is set as coordinates of a two-dimensional coordinate system. The higher the radio score is, the more satisfactory the radio state becomes. The radio mode (the radio means) includes a communication system, a radio frequency, and a radio access point (AP).

Note that in order to acquire a radio wave status for each movement position of the mobile body, it is necessary to measure the radio wave condition for each movement position with a measuring instrument or an access point. A measuring method with a measuring instrument is disclosed in, for example, Japanese Unexamined Patent Application Publication No. 2015-207813, and can be incorporated herein by reference. The information acquisition unit 4 may acquire a measured value of each movement position in advance, or may estimate a radio wave status of the current movement position from the installed access point.

For example, in a place where the radio wave environment is temporally stable (such as an office), radio state information may be fixedly stored in the storage unit 8 or the like. On the other hand, in a place where the radio wave environment changes, the information acquisition unit 4 may appropriately acquire radio state information through radio communication.

The score calculation unit 5 is a specific example of score calculation means. The score calculation unit 5 calculates a radio score with respect to the radio mode (the communication system, the radio frequency, and the radio access point) of the mobile body at each of the current position and the movement position based on the current position of the mobile body detected by the current position detection unit 2, the movement position of the mobile body estimated by the position estimation unit 3, and the radio state information acquired by the information acquisition unit 4.

For example, the score calculation unit 5 calculates a radio score of 45 of a radio access point AP2 (7ch) with respect to the current position (1, 0) of the mobile body based on the radio state information (FIG. 3) acquired by the information acquisition unit 4. The score calculation unit 5 calculates a radio score of 60 of a radio access point AP3 (13ch) with respect to the current position (2, 1) of the mobile body based on the radio state information (FIG. 3) acquired by the information acquisition unit 4.

The radio determination unit 6 is a specific example of radio determination means. The radio determination unit 6 determines whether to change the radio mode of the mobile body based on the radio scores calculated by the score calculation unit 5 with respect to the radio modes of the mobile body at the current position and the movement position.

The radio determination unit 6 adds the radio score with respect to the radio mode of the mobile body at the current position to the radio score with respect to the radio mode of the mobile body at the movement position based on the radio state information acquired by the information acquisition unit 4.

For example, the radio determination unit 6 calculates a radio score (hereinafter referred to as an added radio score) of 130 obtained by adding the radio score of 80 for the radio mode (AP1) of the mobile body at the current position (1, 0) to the radio score of 50 for the radio mode (AP1) of the mobile body at the movement position (2, 1) based on the radio state information (FIG. 3) acquired by the information acquisition unit 4.

Similarly, the radio determination unit 6 adds the radio score of 45 for the radio mode (AP2) of the mobile body at the current position (1, 0) to the radio score of 70 for the radio mode (AP2) of the mobile body at the movement position (2, 1), thereby calculating an added radio score of 115. In this way, the radio determination unit 6 adds the radio scores for each radio mode, and calculates the respective added radio scores.

The radio determination unit 6 selects the radio mode that maximizes the added radio score, and determines to change the radio mode of the mobile body when the radio mode (hereinafter referred to as a selected radio mode) selected by the radio determination unit 6 is different from the radio mode (hereinafter referred to as a current radio mode) that is currently used.

Note that the radio determination unit 6 may perform weighting by multiplying each added radio score by a weighting coefficient. The radio determination unit 6 may select the radio mode that maximizes the added radio score on which weighting has been performed.

Further, the radio determination unit 6 may calculate both an average value of the radio scores with respect to the radio modes of the mobile body at the current position, and an average value of the radio scores with respect to the radio modes of the mobile body at the movement position based on the radio state information acquired by the information acquisition unit 4. The radio determination unit 6 may select the radio mode that maximizes the average radio scores, and may determine to change the radio mode of the mobile body when the selected radio mode is different from the current radio mode. The radio determination unit 6 outputs, to the radio switching unit 7, a result of a determination indicating that the radio mode of the mobile body is changed. The radio switching unit 7 is a specific example of radio switching means.

The radio switching unit 7 switches the current radio mode in accordance with the result of a determination by the radio determination unit 6. The radio switching unit 7 switches the current radio mode to the selected radio mode in accordance with the result of the determination by the radio determination unit 6 indicating that the radio mode of the mobile body is changed.

Incidentally, in, for example, a factory, the radio wave environment changes every moment due to noise from an electric discharge machine and the like, or movement of a large metal object such as a crane. Meanwhile, it is necessary for a mobile body such as an automated guided vehicle to move in an area such as the above one where the radio wave status is poor, and consequently communication may be blocked. For optimization of the radio wave status of the mobile body in the entire factory, it is necessary to recognize and control the radio wave status of the mobile body in real time, and a stable radio communication is thus demanded.

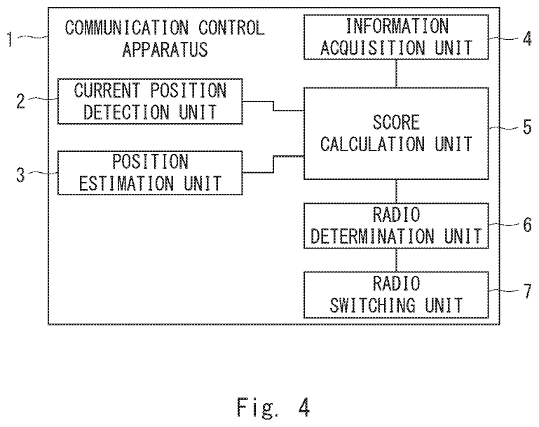

In order to address the above, as shown in FIG. 4, the communication control apparatus 1 according to this example embodiment includes: the current position detection unit 2 that detects a current position of the mobile body; the position estimation unit 3 that estimates a movement position of the mobile body after an elapse of a predetermined amount of time; the information acquisition unit 4 that acquires radio state information in which the position of the mobile body, the radio mode of the mobile body, and the radio score indicating the quality of the radio state with respect to the position and the radio mode of the mobile body are associated with each other; the score calculation unit 5 that calculates a radio score with respect to the radio mode of the mobile body at each of the current position and the movement position based on the current position of the mobile body detected by the current position detection unit 2, the movement position of the mobile body estimated by the position estimation unit 3, and the radio state information acquired by the information acquisition unit 4; the radio determination unit 6 that determines whether or not to change the radio mode of the mobile body based on the radio score calculated by the score calculation unit 5 with respect to the radio mode of the mobile body at each of the current position and the movement position; and the radio switching unit 7 that switches the radio mode of the mobile body in accordance with the result of the determination by the radio determination unit 6.

By this configuration, a stable communication can be maintained by a mobile body such as an automated guided vehicle that moves in a factory. By enabling a stable communication, it is possible to control mobile bodies in the entire factory in real time and optimize the entire operation and movement thereof.

As described above, by associating the current position and the movement position of the mobile body after an elapse of a predetermined amount of time with the information about communication quality, it is possible to switch to an optimal radio mode before the mobile body moves. Further, it is possible to visualize the communication quality corresponding to the movement position in real time. Thus, the communication control apparatus 1 according to this example embodiment can support an environment in which, like in a factory, noise fluctuates in accordance with the rate of operation of production facilities or the radio wave status changes with time. That is, it is possible to apply the communication control apparatus 1 according to this example embodiment not only to an environment in which the radio wave environment is temporally stable but also to an environment in which the radio wave environment changes with time.

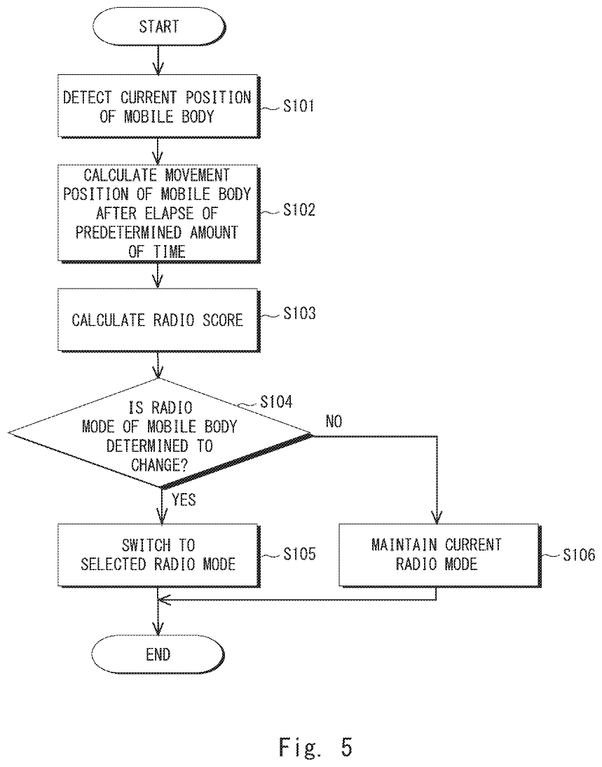

FIG. 5 is a flowchart showing a flow of a communication control method according to this example embodiment of the present disclosure. Note that the processes shown in FIG. 5 are repeatedly performed, for example, at predetermined time intervals.

The current position detection unit 2 detects the current position of the mobile body based on the distance information acquired by the distance sensor, and outputs the detected current position of the mobile body to the score calculation unit 5 (Step S101).

The position estimation unit 3 calculates a movement position of the mobile body after an elapse of a predetermined amount of time based on the current position of the mobile body detected by the current position detection unit 2 and the movement route information stored in the storage unit 8, and outputs the calculated movement position of the mobile body to the score calculation unit 5 (Step S102).

The score calculation unit 5 calculates a radio score with respect to the radio mode (the communication system, the radio frequency, and the radio access point) of the mobile body at each of the current position and the movement position based on the current position of the mobile body detected by the current position detection unit 2, the movement position of the mobile body estimated by the position estimation unit 3, and the radio state information acquired by the information acquisition unit 4, and outputs the calculated radio scores to the radio determination unit 6 (Step S103).

The radio determination unit 6 determines whether or not to change the radio mode of the mobile body based on the radio scores calculated by the score calculation unit 5 with respect to the radio mode of the mobile body at each of the current position and the movement position (Step S104).

When the radio determination unit 6 determines to change the radio mode of the mobile body (YES in Step S104), the radio switching unit 7 switches the current radio mode to the selected radio mode in accordance with the result of the determination by the radio determination unit 6 (Step S105). On the other hand, when the radio determination unit 6 determines to not change the radio mode of the mobile body (NO in Step S104), the radio switching unit 7 maintains the current radio mode in accordance with the result of the determination by the radio determination unit 6 (Step S106).

Several embodiments according to the present disclosure have been explained above. However, these example embodiments are shown as examples but are not shown to limit the scope of the disclosure. These novel example embodiments can be implemented in various forms. Further, their components/structures may be omitted, replaced, or modified without departing from the scope and spirit of the disclosure. These example embodiments and their modifications are included in the scope and the spirit of the disclosure, and included in the scope equivalent to the disclosure specified in the claims.

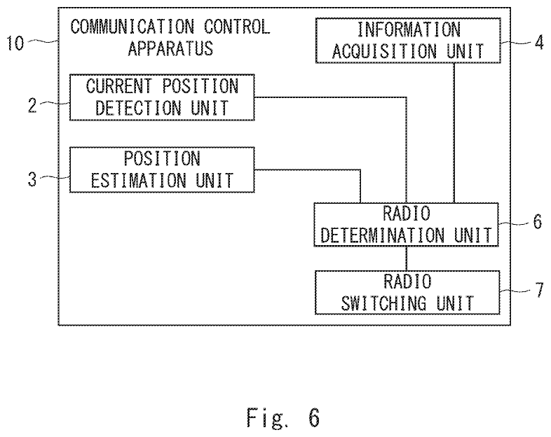

In the aforementioned example embodiment, a communication control apparatus 10 may not include the score calculation unit 5 as shown in FIG. 6. The information acquisition unit 4 acquires radio state information in which the position of the mobile body, the radio mode of the mobile body, and quality information indicating the quality of the radio state with respect to the position and the radio mode of the mobile body are associated with each other. The radio determination unit 6 determines whether or not to change the radio mode of the mobile body by comparing the quality information with respect to the radio mode of the mobile body at the current position with the quality information with respect to the radio mode of the mobile body at the movement position, the quality information being calculated based on the current position of the mobile body, the movement position of the mobile body, and the radio state information. If there are not many options for the radio mode, it is possible to easily determine the quality of the radio state and change the radio mode of the mobile body without calculating the radio scores.

The present disclosure can also be implemented, for example, by causing a CPU to execute a computer program to perform the processes shown in FIG. 5.

The program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.).

The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires and optical fibers) or a wireless communication line.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

What is claimed is:

1. A communication control apparatus, comprising:
current position detection means for detecting a current position of a mobile body;
position estimation means for estimating a movement position of the mobile body after an elapse of a predetermined amount of time;
information acquisition means for acquiring radio state information in which a position of the mobile body, radio means of the mobile body, and quality information indicating a quality of a radio state with respect to the position and the radio means of the mobile body are associated with each other;
radio determination means for determining whether or not to change the radio means of the mobile body by comparing the quality information with respect to the radio means of the mobile body at the current position with the quality information with respect to the radio means of the mobile body at the movement position, the quality information being calculated based on the current position of the mobile body detected by the current position detection means, the movement position of the mobile body estimated by the position estimation means, and the radio state information acquired by the information acquisition means; and;
radio switching means for switching the radio means of the mobile body in accordance with a result of the determination by the radio determination means.

2. The communication control apparatus according to claim 1, further comprising score calculation means for calculating a radio score as the quality information with respect to the radio means of the mobile body at each of the current position and the movement position based on the current position of the mobile body detected by the current position detection means, the movement position of the mobile body estimated by the position estimation means, and the radio state information acquired by the information acquisition means.

3. The communication control apparatus according to claim 2, wherein
the radio determination means adds the radio score with respect to the radio means of the mobile body at the current position to the radio score with respect to the radio means of the mobile body at the movement position based on the radio state information acquired by the information acquisition means, selects the radio means that maximizes the added radio score, and determines to change the radio means of the mobile body when the selected radio means is different from the current radio means, and
the radio switching means switches the current radio means to the radio means selected by the radio determination means in accordance with a result of the determination by the radio determination means.

4. The communication control apparatus according to claim 2, wherein
the radio means of the mobile body includes a communication system, a radio frequency, and a radio access point, and
in the radio state information, the position of the mobile body, the radio means including the communication system, the radio frequency, and the radio access point, and the radio score are associated with each other.

5. A communication control method, comprising:
detecting a current position of a mobile body;
estimating a movement position of the mobile body after an elapse of a predetermined amount of time;
acquiring radio state information in which a position of the mobile body, radio means of the mobile body, and quality information indicating a quality of the radio state with respect to the position and the radio means of the mobile body are associated with each other;
determining whether or not to change the radio means of the mobile body by comparing the quality information with respect to the radio means of the mobile body at the current position with the quality information with respect to the radio means of the mobile body at the movement position, the quality information being calculated based on the detected current position of the mobile body, the estimated movement position of the mobile body, and the acquired radio state information; and
switching the radio means of the mobile body in accordance with the result of the determination.

6. A non-transitory computer readable medium storing a program for causing a computer to execute the following processing of:
detecting a current position of a mobile body;
estimating a movement position of the mobile body after an elapse of a predetermined amount of time;
acquiring radio state information in which a position of the mobile body, radio means of the mobile body, and quality information indicating a quality of the radio state with respect to the position and the radio means of the mobile body are associated with each other;
determining whether or not to change the radio means of the mobile body by comparing the quality information with respect to the radio means of the mobile body at the current position with the quality information with respect to the radio means of the mobile body at the movement position, the quality information being calculated based on the detected current position of the mobile body, the estimated movement position of the mobile body, and the acquired radio state information; and
switching the radio means of the mobile body in accordance with the result of the determination.
